(19) United States
(12) Patent Application Publication
(10) Pub. No.: US 2009/0218718 A1
(43) Pub. Date: Sep. 3, 2009

(54) MANUFACTURING METHOD FOR A MOLD

(75) Inventors: Mitsuo Takeuchi, Kawasaki (JP); Hiroaki Tamura, Kawasaki (JP); Ken-ichi Itoh, Yamato (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/372,410

(22) Filed: Feb. 17, 2009

(30) Foreign Application Priority Data
Feb. 18, 2008 (JP) 2008-036584

(51) Int. Cl. B32B 38/04

(52) U.S. Cl. 264/135; 264/153

(57) ABSTRACT

According to an aspect of an embodiment, a manufacturing method for a mold includes a step of forming a protection film having fluidity on a front surface of a base material on which concave/convex patterns are partitioned, and a step of punching a mold from the base material by causing a male mold to come into a female mold while overlapping a punching surface of the male mold on a back surface of the base material.

### CROSS-REFERENCE TO RELATED APPLICATION

This application is based upon and claims the benefit of priority of the prior Japanese Patent Application No. 2008-36584 filed on Feb. 18, 2008, the entire contents of which are incorporated herein by reference

### BACKGROUND

1. Field

An aspect of the invention relates to a manufacturing method for a mold. The mold is used to make a magnetic medium.

2. Description of the Related Art

A magnetic medium such as a so-called bit patterned medium is assembled to, for example, a hard disc drive unit (HDD). The bit patterned medium has nano holes on a front surface which are disposed, for example, regularly. Magnetic bodies are buried in the nano holes. For example, one magnetic body constitutes one recording bit. The bit patterned medium greatly contributes to improved recording density.

The bit patterned medium is manufactured making use of a mold. Nano-patterns are formed on a front surface of the mold. When an aluminum film is formed on the front surface of the mold, the nano-patterns are transferred onto the aluminum film. The aluminum film is exfoliated from the mold. Thereafter, a front surface of the aluminum film is subjected to an anodic oxidation process. Nano holes are formed on the front surface of the aluminum film. Thereafter, the nano holes are filled with the magnetic bodies.

When a contour of the aluminum film is larger than a contour of the magnetic medium, the contour of the aluminum film is cut out along the contour of the magnetic medium. This is a troublesome process. Accordingly, to simplify the manufacturing process, it is preferable that the contour of the aluminum film agree with the contour of the magnetic medium. In other words, it is preferable that a contour of the mold agree with the contour of the magnetic medium.

When the mold is formed, a nickel film is formed based on, for example, a front surface of a substrate, by electrolytic plating. The nickel film is removed from the substrate. Nano-patterns of the substrate are transferred onto the nickel film. In general, in the electrolytic plating process, the film thickness of the nickel film is increased toward an outer periphery. However, the film thickness of the nickel film, i.e. the thickness of the mold is uniform. Accordingly, an allowance for punching is previously formed in the nickel film along the outer periphery. The nickel film has a uniform film thickness inside of the allowance for punching. The mold is punched from the nickel film.

### [Patent Document 1]

Japanese Laid-open Patent Publication No. 2005-212428

When the mold is punched, a press process, for example, is used. In the press process, a punching surface of a male mold is pressed against a front surface of the nickel film. The nano-patterns are formed on the front surface of the nickel film as described above. Accordingly, the punching surface is pressed against the front surface of the nickel film in a region other than the nano-patterns. As a result, the male mold cannot cause a sufficient load to act on the nickel film. Thus, the nickel film cannot be sufficiently fixed. When the male mold goes into a female mold in this state an outside edge of the mold, for example, is deformed. This mold cannot be used to transfer the nano-patterns.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### SUMMARY

According to an aspect of an embodiment, a manufacturing method for a mold includes a step of forming a protection film having fluidity on a front surface of a base material on which concave/convex patterns are partitioned, and a step of punching a mold from the base material by causing a male mold to come into a female mold while overlapping a punching surface of the male mold on a back surface of the base material.

Additional objects and advantages of the invention will be set forth in part in the description which follows and, in part will be obvious from the description, or may be learned by practice of the present invention. The object and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 is a perspective view schematically showing a structure of a mold;

FIG. 2 is a side elevational view schematically showing a structure of an overlapping member;

FIG. 3 is a side elevational view schematically showing how a protection film is formed on a front surface of the overlapping member;

FIG. 4 is a sectional view schematically showing how the overlapping member is disposed on a female mold;

FIG. 5 is a sectional view schematically showing how a front surface of a base material is overlapped on the front surface of the overlapping member;

FIG. 6 is a sectional view schematically showing how the base material is pressed against the female mold;

FIG. 7 is a sectional view schematically showing how the female mold goes into the male mold a mold is punched thereby;

FIG. 8 is a sectional view schematically showing how the base material is exfoliated from the overlapping member after the mold is punched; and

FIG. 9 is a sectional view schematically showing how the base material is disposed on the female mold.

### DETAILED DESCRIPTION OF THE PREFERRED EMBODIMENTS

An embodiment of the present invention will be explained below referring to the accompanying drawings.

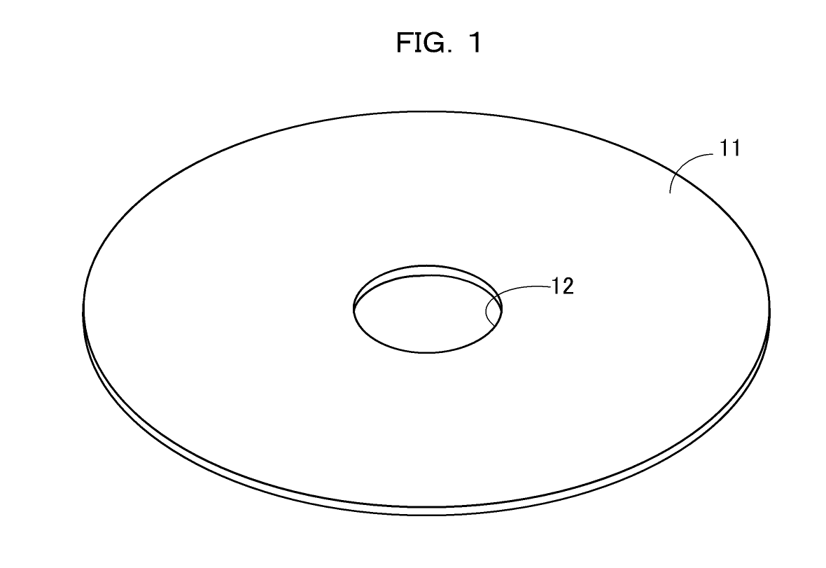

FIG. 1 schematically shows a structure of an object, i.e. a mold 11 according to a specific example. The mold 11 is formed in, for example, a disk-shape. The mold 11 is formed of a metal material, for example, nickel. The mold has a thickness of, for example, about 0.2 mm to 0.3 mm. The mold 11 has the same diameter as that of a magnetic medium as a manufacturing object. The diameter of the mold 11 is set to, for example, 1 inch. A center hole 12 of the mold 11 is formed at the center of the mold 11. The center hole 12 passes through the mold 11 from a front surface to a back surface. The axis of the center hole 12 agrees with the axis of the mold 11.

Nano-patterns i.e. concave/convex patterns (not shown) to be described later are partitioned on a front surface of the mold 11. The concave/convex patterns partition predetermined concaves and convexes according to, for example, a shape of recording tracks of a magnetic medium. A difference in height of the concaves and convexes is set to, for example, about 100 nm. The concave/convex patterns are formed based on, for example, an electrolytic plating method. When the concave/convex patterns are formed, a nickel film is formed on a substrate on a front surface on which, for example, the concave/convex patterns are previously formed. After the nickel film is formed, it is exfoliated from the substrate. With this operation, the concave/convex patterns are transferred onto a front surface of the nickel film. However, the transferred patterns may be formed by, for example, radiating an electron beam.

The mold 11 described above is used when a magnetic storage medium such as a so-called discrete track medium and a so-called bit patterned medium, i.e. a magnetic medium is manufactured. When the magnetic medium is manufactured, first, an aluminum film is formed to a uniform film thickness on the front surface of the mold 11. When the aluminum film is formed, a well-known sputtering method is executed. A glass substrate, for example, is bonded on a back surface of the aluminum film. An adhesive is used to bond the glass substrate. The aluminum film is exfoliated from the mold 11 together with the glass substrate. With this operation, the concave/convex patterns are transferred onto the front surface of the aluminum film.

Thereafter, the front surface of the aluminum film is subjected to an anodic oxidation process. The front surface of the aluminum film is oxidized by the anodic oxidation process. As a result, so-called nano holes grow from the concave/convex patterns. The front surface of the aluminum film is changed to an alumina film. The nano holes formed as described above are filled with magnetic bodies. After the magnetic bodies are filled, the front surface of the aluminum film is subjected to a polishing process. Thereafter, a DLC film and a lubricating film are formed on the front surface of the aluminum film. The magnetic medium is manufactured as described above.

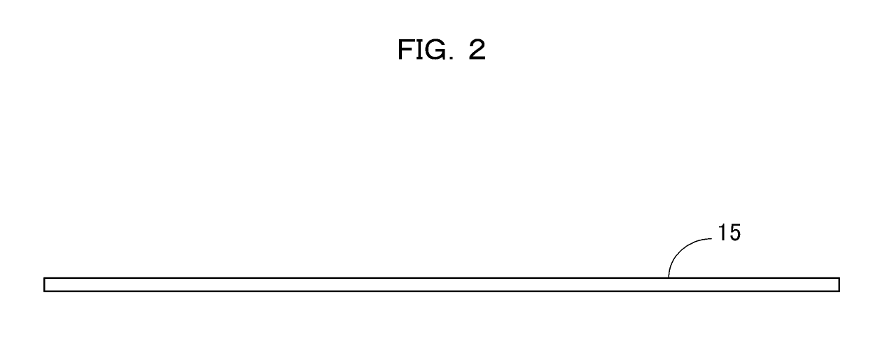

Next, a method of manufacturing the mold 11 will be explained. As shown in FIG. 2, in the manufacture of the mold 11, first, a disk-shaped overlapping member 15, for example, is prepared. The diameter of the overlapping member 15 is set larger than that of the mold 11. The overlapping member 15 is formed somewhat larger than that of the mold 11. That is, the overlapping member 15 is provided with an allowance for punching. Here, the overlapping member 15 has a diameter of, for example, about 50 mm. The overlapping member 15 has a uniform thickness. The overlapping member 15 is formed of a solid. Here, the overlapping member 15 is formed of a metal material, for example, nickel.

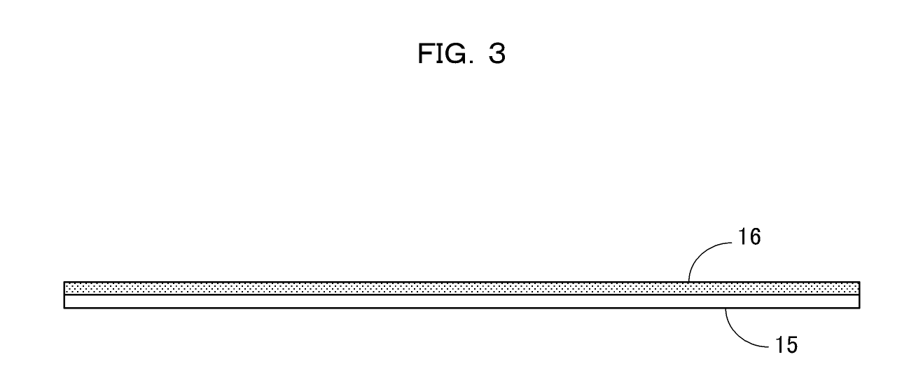

A resin material, i.e. a thermoplastic material is coated on the front surface of the overlapping member 15. A spin coating method, for example, is executed to coat the resin material. Thermoplastic resin such as polymethylmethacrylate resin (PMMA) is used as the resin material. When the spin coating method is executed, the resin material is heated to a predetermined temperature. As a result, as shown in FIG. 3, a protection film 16 having a uniform film thickness is formed on the front surface of the overlapping member 15. The protection film 16 has a film thickness larger than the difference in height of the concaves and convexes partitioned on the front surface of the mold 11 described above. Here, the protection film 16 has a film thickness of, for example, about 150 nm.

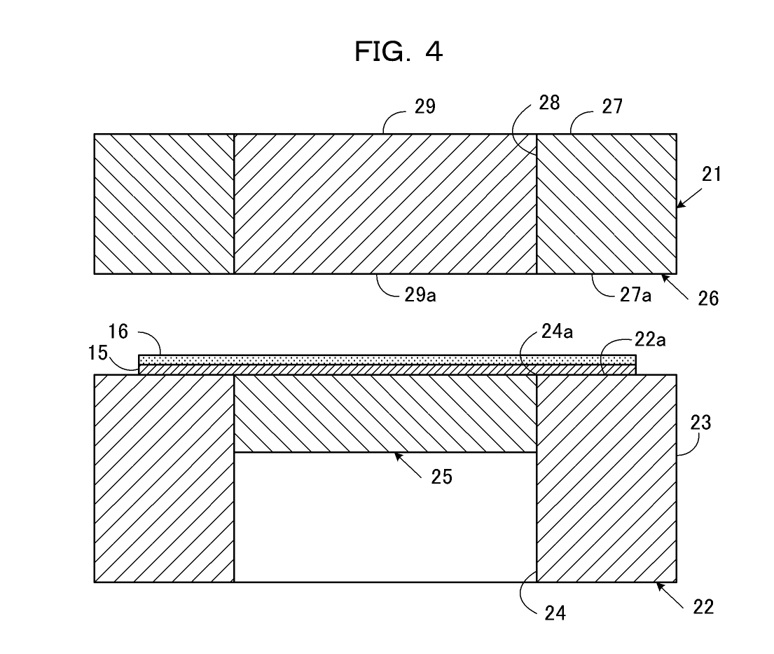

Subsequently, as shown in FIG. 4, a press machine 21 is prepared. The press machine 21 has a die plate 22. The die plate 22 has a female mold 23. A front surface of the female mold 23 is formed in a flat surface. A columnar guide hole 24 is formed to the female mold 23. The guide hole 24 extends in a vertical direction orthogonal to the front surface of the female mold 23. The guide hole 24 has a diameter of, for example, 1 inch. The guide hole 24 has an opening 24a on the front surface of the female mold 23. A columnar receiving member 25 is disposed to the opening 24a of the guide hole 24. The receiving member 25 is exposed to the front surface of the female mold 23 through the opening 24a. The guide hole 24 guides movement of the receiving member 25 in a vertical direction.

A front surface of the receiving member 25 is formed in a flat surface. Accordingly, when the receiving member 25 is positioned at, for example, a reference position, the front surface of the receiving member 25 is made flush with the front surface of the female mold 23. At that time, a flat surface 22a is formed by the female mold 23 and the receiving member 25. A contour on the front surface of the receiving member 25 is formed in the shape of a contour of the mold 11. The receiving member 25 is formed of, for example, a metal material. A heater (not shown) is assembled to the receiving member 25. The heater can increase the temperatures of the receiving member 25 and the female mold 23 by the heat generated thereby. The heater may be formed of, for example, an electrically heating wire.

The press machine 21 has a press mechanism 26. The press mechanism 26 can relatively move along the axial center of the guide hole 24 with respect to the die plate 22. The press mechanism 26 has a support block 27. A lower surface of the support block 27 is formed in a flat surface. A columnar guide hole 28 is formed to the support block 27. The guide hole 28 extends in the vertical direction orthogonal to the flat surface 22a of the die plate 22. The guide hole 28 has a diameter of, for example, 1 inch. A columnar male mold 29 is received by the guide hole 28. The male mold 29 is exposed to the lower surface of the support block 27. The guide hole 28 guides movement of the male mold 29 in the vertical direction.

An extreme end surface, i.e. a punching surface 29a of the male mold 29 is formed in a flat surface. Accordingly, when the male mold 29 is positioned to for example, the reference position, the lower surface of the support block 27 and the punching surface 29a of the male mold 29 are made flush with each other. At that time, a flat surface 27a is formed by the lower surface of the support block 27 and the punching surface 29a of the male mold 29. The flat surface 27a spreads in parallel with the flat surface 22a of the die plate 22. The male mold 29 and the receiving member 25 define a contour along a column drawn by the same bus. The punching surface 29a has a diameter of, for example, 1 inch. With this arrangement, the male mold 29 can come into the female mold 23, i.e. into the guide hole 24.

The die plate 22 has the overlapping member 15 disposed at a predetermined position of the flat surface 22a. When the overlapping member 15 is disposed, the axis of the overlapping member 15 is aligned with the axis of the receiving member 25. The heater of the receiving member 25 heats the receiving member 25 and female mold 23. Heat is transmitted to the overlapping member 15. The temperatures of the overlapping member 15 and the protection film 16 are increased. The temperature of the protection film 16 is set to, for example, about 100° C. to 120° C. As a result, the protection film 16 is softened on the front surface of the overlapping member 15. The protection film 16 has fluidity. The fluidity of the protection film 16 is maintained by the temperature of the heater.

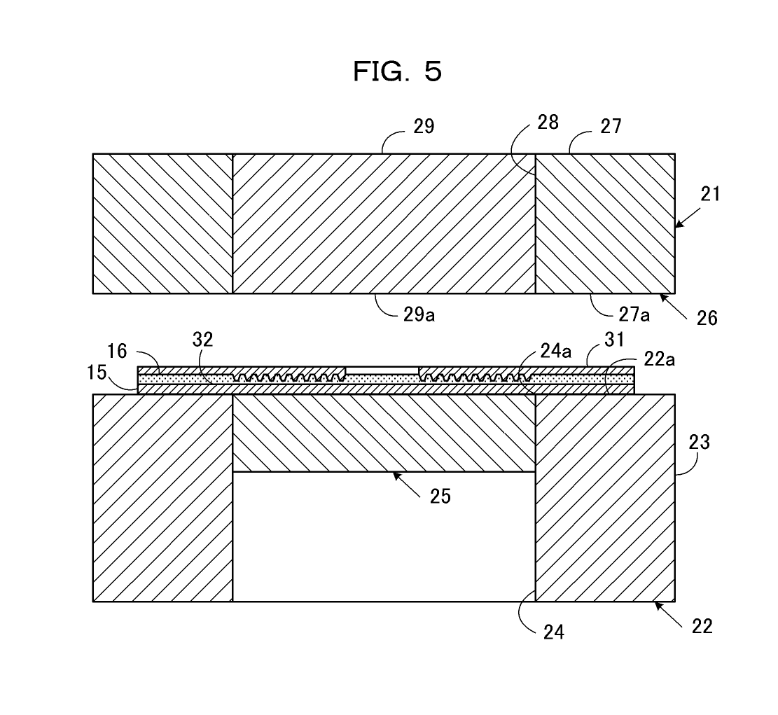

At the time, as shown in FIG. 5, the front surface of the overlapping member 15 is overlapped with a disk-shaped nano pattern member, i.e. a front surface of a base material 31. Concave/convex patterns 32 are formed on the front surface of the base material 31, i.e. a nano pattern forming surface. The concave/convex patterns 32 are formed on the front surface of the base material 31 inward of the allowance for punching. The base material 31 is formed of simple nickel. The contour of the base material 31 is caused to conform with, for example, the contour of the overlapping member 15. Here, the base material 31 has a diameter of, for example, about 50 mm. Thus, an allowance for punching is formed in the base material 31 similar to that of the overlapping member 15. Here, a mold lubricant (not shown) is coated on the front surface of the base material 31 before the base material 31 is overlapped with the overlapping member 15.

When the base material 31 is overlapped with the overlapping member 15, the protection film 16 is clamped between the front surface of the overlapping member 15 and the front surface of the base material 31 by the action of the fluidity of the protection film 16. When the base material 31 is overlapped with the overlapping member 15, the environment in the periphery of the press machine 21 is set to a pressure lower than the atmospheric pressure. Here, the pressure is set to, for example, about one tenth the atmospheric pressure. As a result, the protection film 16 sufficiently comes into intimate contact with the concave/convex patterns 32 of the base material 31 and with the overlapping member 15. Air is expunged from between the protection film 16 and the base material 31 and the overlapping member 15.

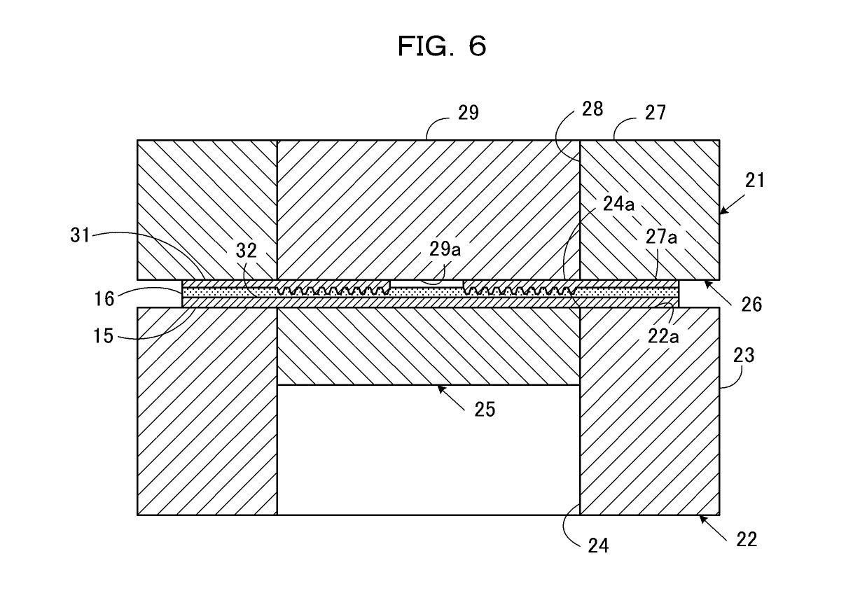

As shown in FIG. 6, the press mechanism 26 presses the base material 31 against the die plate 22 through the flat surface 27a. The male mold 29 is received and stopped on the back surface of the base material 31 by the punching surface 29a. With this arrangement, the base material 31 and the overlapping member 15 are clamped between the punching surface 29a and the front surface of the receiving member 25. The lower surface of the support block 27 is received and stopped by the base material 31 in the periphery of the punching surface 29a. With this arrangement, the base material 31 and the overlapping member 15 are clamped by the flat surface 22a and the flat surface 27a. At that time, it is sufficient for the environment in the periphery of the press machine 21 to be set to the atmospheric pressure. The press force is set to, for example, about several hundreds of [Pa] to several tens of [kPa].

As described above, the protection film 16 has fluidity. As a result, the protection film 16 comes securely into the concaves and convexes of the concave/convex patterns 32 of the base material 31 by the press force. The protection film 16 sufficiently comes into intimate contact with the overlapping member 15 and the base material 31. With this arrangement, the base material 31 and the overlapping member 15 are securely held at a predetermined position between the flat surface 22a and the flat surface 27a. Since the base material 31 and the overlapping member 15 are clamped between the flat surfaces 22a, 27a, they are prevented from being deformed. Moreover, since the film thickness of the protection film 16 is larger than the concaves and convexes of the concave/convex patterns 32, the concave/convex patterns 32 of the base material 31 do not come into contact with the overlapping member 15. Thus, damage to the concave/convex patterns 32 can be avoided.

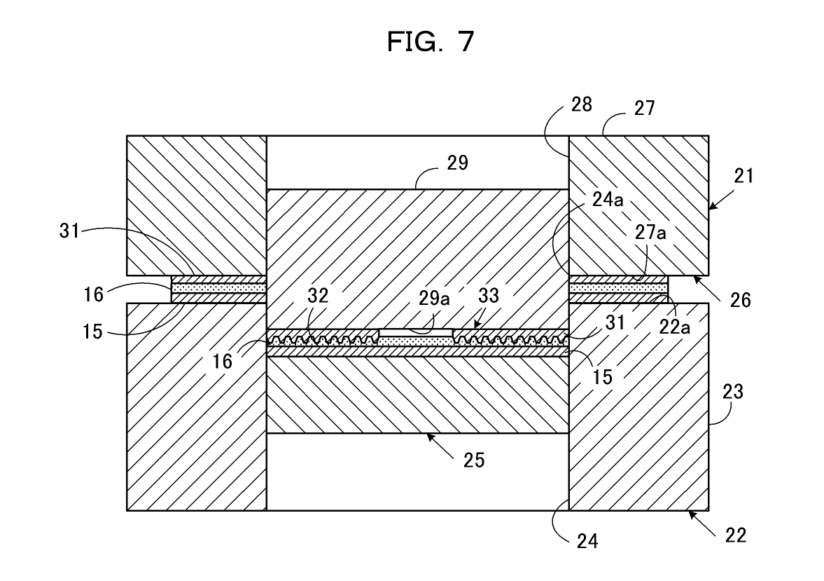

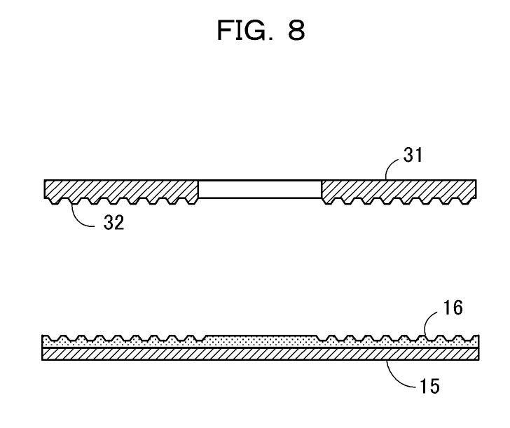

At that time, as shown in FIG. 7, the male mold 29 instantly falls toward the female mold 23 in a direction orthogonal to the front surface of the base material 31, i.e. in parallel with a direction in which the base material 31 and the overlapping member 15 are laminated. The male mold 29 punches a punching component 33 from the base material 31 and the overlapping member 15 along a contour of the punching surface 29a. The male mold 29 goes into the guide hole 24 of the female mold 23. After the punching component 33 is punched, it is taken out from the press machine 21. The punching component 33 is cooled to room temperature. As a result, the protection film 16 is hardened. Thereafter, as shown in FIG. 8, the base material 31 after it is punched, i.e. the mold 11 is taken away from the protection film 16. Since the mold lubricant is coated on the front surface of the base material 31, taking out the mold 11 can be easily executed. The mold 11 is manufactured as described above.

According to the manufacturing method of the mold 11, the protection film 16 having the fluidity is clamped between the base material 31 and the overlapping member 15. As a result, the male mold 29 can press the base material 31 against the flat surface 22a through the entire punching surface 29a formed by the flat surface. The base material 31 is securely held at a predetermined position. Moreover, a press force, which acts from the punching surface 29a when the punching component 33 is punched, is absorbed by the protection film 16. Deformation of the base material 31 is suppressed. Damage to the concave/convex patterns 32 of the base material 31 is avoided. The mold 11 is manufactured with pinpoint accuracy. Since the mold 11 is simply punched as described above, high mass productivity is sufficiently realized. Moreover, since the protection film 16 is clamped between the base material 31 and the overlapping member 15, the protection film 16 is not adhered to the male mold 29, the female mold 23, and the receiving member 25.

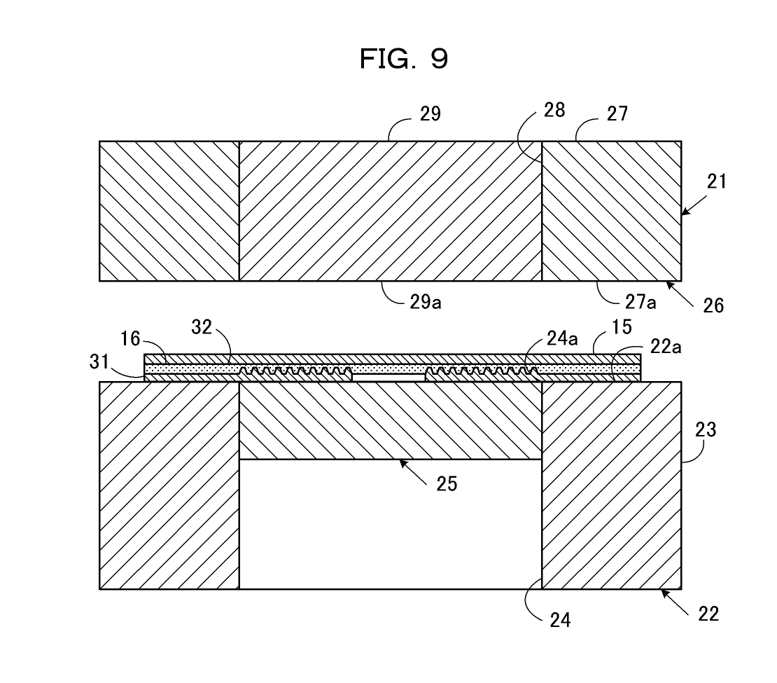

In the manufacturing method of the mold 11 described above, when the base material 31 is overlapped with the overlapping member 15, the base material 31 may be disposed on the flat surface 22a of the die plate 22 first as shown in FIG. 9. It is sufficient for the front surface of the overlapping member 15 to be overlapped with the front surface of the base material 31. Thus, the flat surface 27a of the press mechanism 26 is received and stopped by a back surface of the overlapping member 15. The male mold 29 punches the overlapping member 15 and the base material 31 in this order. The mold 11 may be manufactured as described above. With this operation, the same operation/working-effect as that described above can be realized.

Further, the overlapping member 15 may use a metal material softer than, for example, nickel. The metal material includes, for example, copper, aluminum, and brass. When the mold 11 is manufactured by the overlapping member 15 made of the soft metal material, it can be deformed prior to the base material 31 formed of nickel. As a result, the overlapping member 15 can absorb the press force acting from the male mold 29 in addition to the protection film 16. Accordingly, the deformation of the base material 31 is further avoided, and the mold 11 is manufactured with a more pinpoint accuracy.

As described above, according to the present invention, there is provided a manufacturing method of an object having a pinpoint accuracy.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A manufacturing method for a mold object comprising:
a step of forming a protection film having fluidity on a front surface of a base material on which concave/convex patterns are partitioned; and
a step of punching the mold from the base material by causing a male mold to come into a female mold while overlapping a punching surface of the male mold on a back surface of the base material.

2. The manufacturing method according to claim 1, wherein when the punching surface is overlapped, the base material and the protection film are clamped between the punching surface and a receiving member which is disposed in an opening for receiving the male mold by the female mold.

3. The manufacturing method according to claim 2, wherein when the punching surface is overlapped, a solid overlapping member is clamped between the protection film and the receiving member.

4. The manufacturing method according to claim 3 wherein when the punching surface is overlapped, a pressure lower than the atmospheric pressure is set.

5. The manufacturing method according to claim 1, wherein the protection film is formed of thermoplastic resin.

6. The manufacturing method according to claim 5, wherein the thermoplastic resin is formed of polymethylmethacrylate resin and maintained at a temperature of 100° C. to 120° C.

7. A manufacturing method for a mold comprising:
a step of coating a thermoplastic material on a flat surface of a member;
a step of overlapping a nano pattern forming surface of a nano pattern member on the flat surface of the member;
a step of heating the thermoplastic material; and
a step of cutting out a mold from the nano pattern member by executing press in parallel with a direction in which the member, the thermoplastic material, and the nano pattern member are laminated.

8. The manufacturing method according to claim 7, wherein a mold lubricant is coated onto the nano pattern forming surface of the nano pattern member before the nano pattern forming surface is overlapped.

9. The manufacturing method according to claim 7, wherein the thermoplastic material is formed of polymethylmethacrylate resin, and a heating temperature is 100° C. to 120° C.

10. The manufacturing method according to claim 7, wherein the member contains nickel.

11. The manufacturing method according to claim 7, wherein when the nano pattern forming surface is overlapped, a pressure lower than the atmospheric pressure is set.

12. A manufacturing method for a magnetic medium comprising:
forming a nano pattern according to a shape of the nano pattern by using a mold by manufacturing method according to claim 1.

13. A manufacturing method for a magnetic medium comprising:
forming a nano pattern according to a shape of the nano pattern by using a mold by manufacturing method according to claim 7.
